(19) United States
(12) Patent Application Publication
(10) Pub. No.: US 2019/0350788 A1
(43) Pub. Date: Nov. 21, 2019

(54) ADJUSTABLE LEG LIFT

(71) Applicant: DANNY MOYA, WAXAHACHIE, TX (US)

(72) Inventor: DANNY MOYA, WAXAHACHIE, TX (US)

(21) Appl. No.: 15/981,227

(22) Filed: May 16, 2018

(51) Int. Cl. A61G 7/075

(52) U.S. Cl. CPC A61G 7/0755

(57) ABSTRACT

A leg lift to elevate a user's leg that includes: a first frame, where the first frame includes three sides, a resting side, an elevation side and a base and said base includes a series of slots for placement of the elevation side; a second frame, where the second frame includes three sides, a resting side, an elevation side and a base and said base includes a series of slots for placement of the elevation side; and a leg rest attached between the first frame and the second frame, where the leg rest is attached between the resting side of each frame. Hinges are preferably used to adjoin each side of the first frame and the second frame.

### BACKGROUND OF THE INVENTION

### Field of Invention

The present invention relates to an adjustable leg lift to elevate an individual's leg.

### Description of Related Art

Many times an individual may suffer an injury that may require elevation of a limb to minimize inflammation and swelling. This elevation requirement is particularly recommended, where an individual's ankle, foot or knee may be injured. Many times individuals are confined to their beds during the healing process. In order to alleviate pain and inflammation associated with a leg injury, it is normally required that an individual keep their foot elevated. However, it may be difficult to keep the leg stationary and elevated while resting in the bed. Individuals normally use different types of pillows or other props to elevate the leg. However it would be advantageous to have a device that keeps the leg in a stationary position and elevated comfortably. Further it would be advantageous to have a device, where the degree of elevation could vary.

### SUMMARY OF THE INVENTION

The present invention relates to a leg lift to elevate a user's leg that includes: a first frame, where the first frame includes three sides, a resting side, an elevation side and a base and said base includes a series of slots for placement of the elevation side; a second frame, where the second frame includes three sides, a resting side, an elevation side and a base and said base includes a series of slots for placement of the elevation side; and a leg rest attached between the first frame and the second frame, where the leg rest is attached between the resting side of each frame. Hinges are preferably used to adjoin each side of the first frame and the second frame.

### BRIEF DESCRIPTION OF DRAWINGS

FIG. 1 depicts a leg lift in accordance with the present invention.

FIG. 2A shows use of the leg lift in a first embodiment.

FIG. 2B shows use of the leg lift in a second embodiment.

### DETAILED DESCRIPTION

The present invention relates to a leg lift that is portable and mountable in a consumer's bed, couch or home. The leg lift of the present invention includes a first trianglar frame and a second trianglar frame, where a leg rest is mounted in between the frames for placing an individual's leg. The frames are adjustable to give the user an opportunity to adjust the angle of the leg lift along the resting side. The leg rest adjoins an elevation side that connects to the base. The base includes a series of notches or slots that allow movement of the elevation side to vary the angle of the resting side of these triangular frames. These are moved in conjunction and enables the user to easily adjust the angle of the resting side.

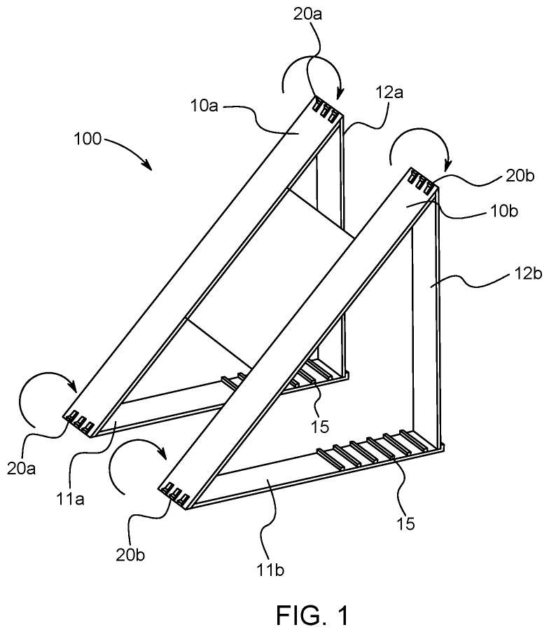

A perspective view of the leg lift according to the present invention is depicted in FIG. 1. Leg Lift 100 includes the first triangular frame and second triangular frame. Each triangle frame has three sides, where a first side 10a, 10b are shown on each respective frame. This first side 10a, 10b may is preferably a resting side and includes a leg rest 25 that extends between the erect triangular frames. Once placed in a stationary position a user may place their leg in the leg rest 25 at an angle therefore keeping their leg in an elevated position. Hinges 20a,20b are used to adjoin the resting side 10a, 10b to the elevation side 12a, 12b and base 11a, 11b. The hinges 20a, 20b create a hinge-type movement of the sides of the leg lift according to the present invention. Slots 15 are provided on the base side 11a, 11b with respective rectangular frame. These slots 15 enable the movement of the vertical side 12a, 12b to an appropriate angle for resting as desired by the user.

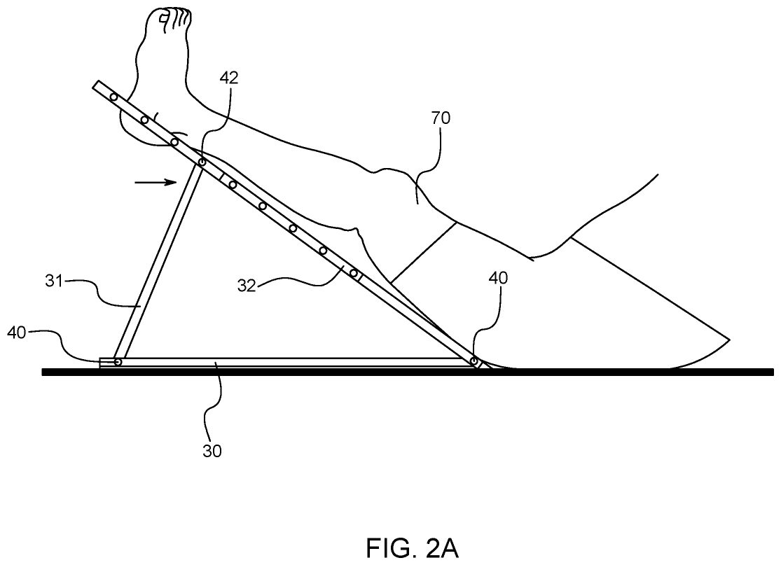

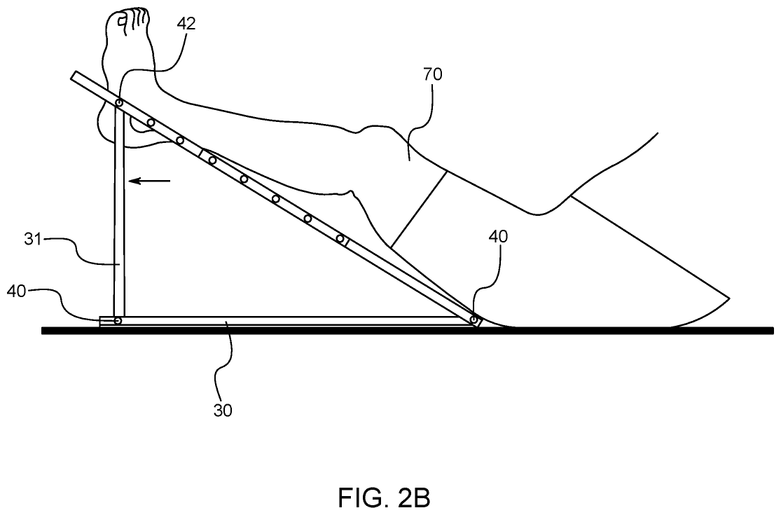

FIG. 2A shows a side view of the leg lift 100 according to the present invention. In this particular side view a second embodiment of the leg lift 100 is shown. Here the vertical sides 31 attach to a base 30 at the hinge 40. A second hinge attaches the resting side on 32 to base 30. In this particular embodiment matches a place along the resting side 32 to allow movement of the vertical side 31 to vary the angle of the leg lift 100. This view is further shown in FIG. 2B, where a increase in the elevation is shown by movement of the vertical side 31 along the resting side 32 to enable the change in elevation angle.

The vertical frames provide a sturdy stationary support for the leg lift and therefore prevents any undesired movement of the leg while in an elevated position. This facilitates effective elevation of the leg and ensures that the user can effectively use the device in any setting. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A leg lift to elevate a user's leg comprising:
a. a first frame, where the first frame includes three sides, a resting side, an elevation side and a base and said base includes a series of slots for placement of the elevation side;
b. a second frame, where the second frame includes three sides, a resting side, an elevation side and a base and said base includes a series of slots for placement of the elevation side; and
c. a leg rest attached between the first frame and the second frame, where the leg rest is attached between the resting side of each frame.

2. The leg lift according to claim 1, where hinges are used to adjoin each side of the first frame and the second frame.

3. A leg lift to elevate a user's leg comprising:
a. a first frame, where the first frame includes three sides, a resting side, an elevation side and a base and said resting side includes a series of slots for placement of the elevation side;
b. a second frame, where the second frame includes three sides, a resting side, an elevation side and a base and said resting side includes a series of slots for placement of the elevation side; and
c. a leg rest attached between the first frame and the second frame, where the leg rest is attached between the resting side of each frame.

4. The leg lift according to claim 1, where hinges are used to adjoin each side of the first frame and the second frame.
